(19) United States
(12) Patent Application Publication
(10) Pub. No.: US 2008/0075017 A1
(43) Pub. Date: Mar. 27, 2008

(54) System and Method for Analyzing Dynamics of Communications in a Network

(76) Inventor: Stephen Patrick Kramer, Austin, TX (US)

Correspondence Address: Giorgos A. Georgakis;Chowdhury & Georgakis, PC, PO BOX 90277, AUSTIN, TX, 78709-0277, US

(21) Appl. No.: 11/534,206

(22) Filed: Sep. 21, 2006

(51) Int. Cl. H04J 1/16

(52) U.S. Cl. 370/252; 370/401

(57) ABSTRACT

Systems and methods for identifying mediated communications in a network of nodes, including: determining the number of direct communications between a first node and a second node, the communications occurring in either direction; determining the number of indirect communications between the first node and the second node through the one or more mediator nodes, the communications occurring in either direction; and comparing the number of direct communications to the number of indirect communications.

### I. BACKGROUND

A. Field of the Invention

The invention relates generally to the field of complex network. In particular, the invention relates to the analysis of the dynamics of communication patterns in networks.

B. Description of the Related Art

The field of complex network research spans work in a broad range of scientific disciplines, including graph theory in discrete mathematics and computer science, social network analysis in sociology, protein and DNA analysis in computational biology, and complex systems research in physics and mathematics. For an extensive review of network research, consult the review article “The structure and function of complex networks” by Prof. Mark E. Newman (SIAM Review 45, 167-256 (2003)).

Newman divides networks into four categories: social networks, information networks, technological networks, and biological networks. The systems and methods described herein could be applied to the analysis of networks in any of these groups; the interpretation of analysis results would vary according to the type of network studied.

### II. SUMMARY

In one respect, disclosed is a method for identifying mediated communications in a network of nodes, the method comprising: determining the number of direct communications between a first node and a second node; determining the number of indirect communications between the first node and the second node through one or more mediator nodes; and comparing the number of direct communications to the number of indirect communications.

In another respect, disclosed is an information handling system for identifying mediated communications in a network of nodes, the system comprising: one or more memory units; one or more processor units; and one or more input/output devices, wherein the system is operable to: determine the number of direct communications between a first node and a second node; determine the number of indirect communications between the first node and the second node through one or more mediator nodes; and compare the number of direct communications to the number of indirect communications.

In yet another respect, disclosed is a computer program product stored on a computer operable medium, the computer program product comprising software code being effective to: determine the number of direct communications between a first node and a second node; determine the number of indirect communications between the first node and the second node through one or more mediator nodes; and compare the number of direct communications to the number of indirect communications.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a diagram of the nodes (or vertices) and directed edges (or links) in one possible network, in accordance with one embodiment.

FIG. 2 is a diagram showing one example of a timeline of events involving nodes in a network, in accordance with one embodiment.

FIG. 3 is a diagram showing examples of direct communications between two nodes and indirect communications between the two nodes through a mediator node, in accordance with one embodiment.

FIG. 4 is a diagram showing examples of direct communications between two nodes and indirect communications between the two nodes through a mediator node in opposite directions to those shown in FIG. 3, in accordance with one embodiment.

FIG. 5 is a diagram showing examples of the short-term and long-term neighborhoods of a node for averaging the numbers of communications over both a short time period and a long time period, in accordance with one embodiment.

FIG. 6 is a flowchart diagram illustrating a method for comparing the number of direct and indirect communications, in accordance with one embodiment.

FIG. 7 is a flowchart diagram illustrating a method for determining the ratio of indirect communications to the sum of indirect communications and direct communications, in accordance with one embodiment.

FIG. 8 is a flowchart diagram illustrating a method for filtering communications based on the times of occurrence of each communication, in accordance with one embodiment.

FIG. 9 is a flowchart diagram illustrating a method for filtering communications based on one or more filtering conditions, in accordance with one embodiment.

FIG. 10 is a flowchart diagram illustrating a method for filtering communications based on one or more filtering conditions from a list of example conditions, in accordance with one embodiment.

FIG. 11 is a flowchart diagram illustrating a method for filtering network nodes based on one or more filtering conditions, in accordance with one embodiment.

FIG. 12 is a flowchart diagram illustrating a method for filtering network nodes based on one or more filtering conditions from a list of example conditions, in accordance with one embodiment.

FIG. 13 is a flowchart diagram illustrating a method for determining a normalized number of indirect communications through a mediator node, in accordance with one embodiment.

FIG. 14 is a flowchart diagram illustrating a method for comparing a long-term, time-averaged number of communications to a short-term, time-averaged number of communications to determine a communication pattern change over time, in accordance with one embodiment.

FIG. 15 is a flowchart diagram illustrating a method for comparing a long-term, neighborhood-averaged number of communications to a short-term, neighborhood-averaged number of communications to determine a communication pattern change over time, in accordance with one embodiment.

FIG. 16 is a flowchart diagram illustrating a method for comparing a long-term, time-averaged number of incoming communications to a short-term, time-averaged number of incoming communications to determine a communication pattern change over time, in accordance with one embodiment.

FIG. 17 is a flowchart diagram illustrating a method for comparing a long-term, time-averaged number of outgoing communications to a short-term, time-averaged number of outgoing communications to determine a communication pattern change over time, in accordance with one embodiment.

FIG. 18 is a flowchart diagram illustrating a method for determining a long-term, time-averaged number of communications involving a node by linear time averaging, in accordance with one embodiment.

FIG. 19 is a flowchart diagram illustrating a method for determining a short-term, time-averaged number of communications involving a node by linear time averaging, in accordance with one embodiment.

FIG. 20 is a flowchart diagram illustrating a method for determining a short-term, time-averaged number of communications involving a node by exponential time averaging, in accordance with one embodiment.

FIG. 21 is a block diagram illustrating one possible embodiment in an information handling system using either or both of a software implementation and a hardware implementation of network analysis.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

As stated earlier, one can classify networks, in one classification scheme, into four categories (among others): social networks, information networks, technological networks, and biological networks. The methods and systems described herein could be applied to the analysis of networks in any of these groups or others; the interpretation of analysis results would vary according to the type of network studied.

Note: Throughout the following description, “ex:” stands for “for example.”

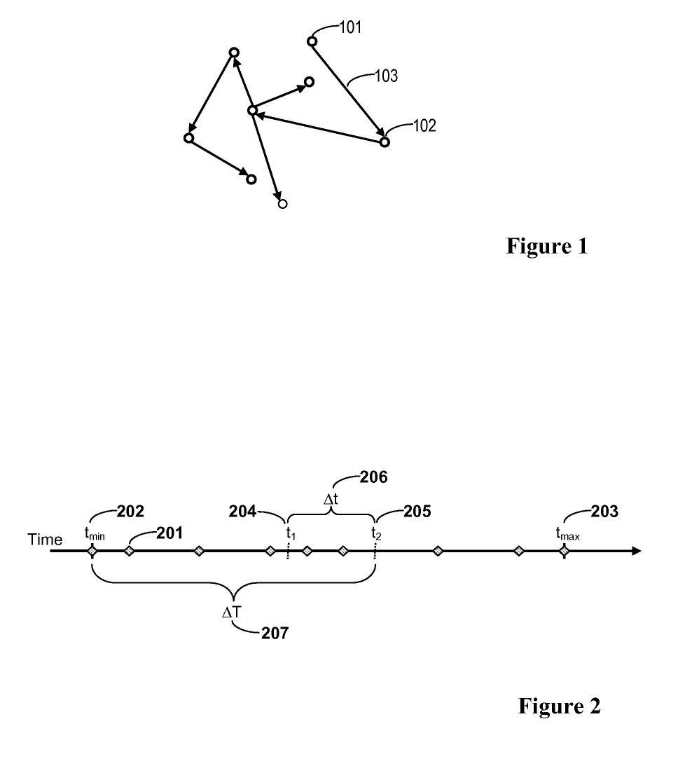

FIG. 1 is a diagram of the nodes (or vertices) and directed edges (or links) in one possible network. In one embodiment as shown in FIG. 1, one of the directed edges (ex: 103) starts at a source node (ex: 101) and terminates at a destination node (ex: 102). In one embodiment, the convention of attributed relational graphs may be followed, in which each directed edge can have multiple attributes, or properties.

In the example of a social communication network, such attributes might include an identifier of the source node, an identifier of the destination node, a date/timestamp of the communication, the duration of the communication (where applicable), the communication medium (land line telephone call, mobile telephone call, satellite telephone call, e-mail, instant message, mail, etc.), and so forth.

In the example of transmission packets in a technological network such as the Internet, such attributes might include an identifier of the source node, an identifier of the destination node, a date/timestamp of the transmission, the packet length, the IP address of the originating host, and so forth.

FIG. 2 is a diagram showing one example of an ordered timeline of events involving nodes in a network. In one embodiment, each event (ex: 201) corresponds to a directed edge (ex: 103), or link, in the equivalent network, or directed graph, exemplified by FIG. 1. In the communication example of FIG. 2, the events have been ordered according to the date/timestamps of the events, although in other network applications, alternative properties could be used to order the events. In FIG. 2, the date/timestamps of the events range from the earliest one tₘᵢₙ (202) to the greatest one tₘₐₓ (203).

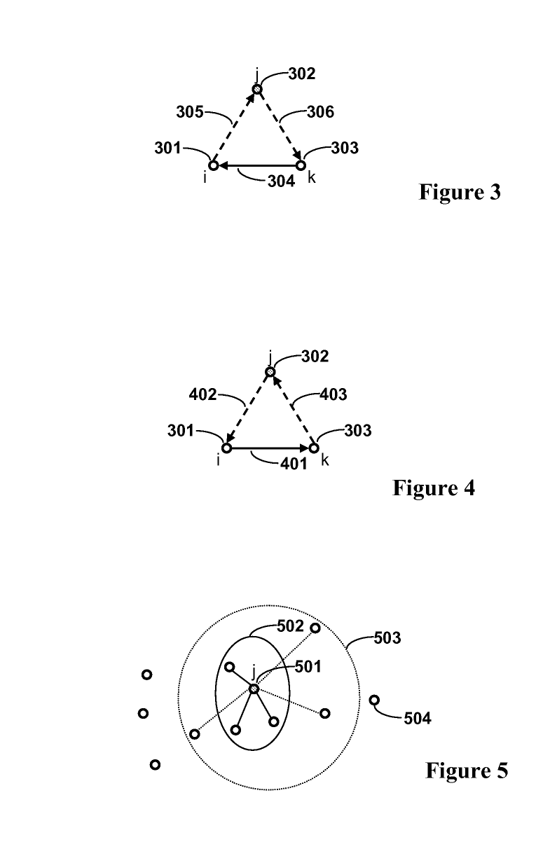

FIG. 3 is a diagram showing examples of direct communications (ex: 304) between two nodes (ex: 301 and 303) and indirect communications (ex: 305 and 306) between the two nodes through a mediator node (302). Only a single mediator node is shown in FIG. 3, but multiple mediator nodes could be used.

FIG. 4 is a diagram showing examples of direct communications (ex: 401) between two nodes (ex: 301 and 303) and indirect communications (ex: 403 and 402) between the two nodes through a mediator node (302) in the opposite directions to those of FIG. 3. Only a single mediator node is shown in FIG. 4, but multiple mediator nodes could be used.

FIG. 5 is a diagram showing examples of the short-term (ex: 502) and long-term (ex: 503) neighborhoods of a node j (ex: 501) for averaging the numbers of communications over both a short time period Δt (ex: 206) and a long time period ΔT (ex: 207), respectively, in accordance with one embodiment. In FIG. 5, the node labeled 504 is one example of nodes outside of both the short-term and long-term neighborhoods for node j (501).

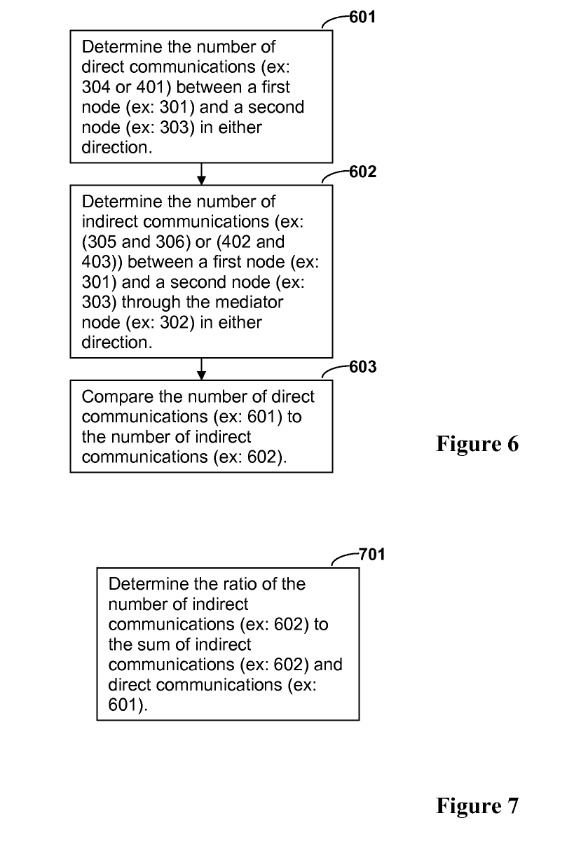

FIG. 6 is a flowchart diagram illustrating a method for comparing the number of direct and indirect communications, in accordance with one embodiment, including:
Block 601: Determine the number of direct communications Tᵢ₀ₖ (ex: 304 or 401) between a first node i (ex: 301) and a second node k (ex: 303) in either direction.
Block 602: Determine the number of indirect communications (ex: (305 and 306) or (402 and 403)) such as Tᵢⱼₖ between a first node i (ex: 301) and a second node k (ex: 303) through the mediator node j (ex: 302) in either direction. In the example shown, an indirect communication is defined to be a communication in two or more segments that is never interrupted by a direct communication within a given time frame. In one embodiment, the time frame is bounded by the segments that compose the mediated communication. If desired, in determining the indirect communications, one can impose a maximum allowed time difference δtₘₐₓ between the segments of a mediated communication. That is, if the time difference between the segments of a potential mediated communication exceeds δtₘₐₓ, then that instance would not qualify as a mediated communication. It should also be noted that if one were to implement this using multiple mediators, then additional subscripts would be needed to designate the number of indirect communications. For example, using two mediator nodes, one could write Tᵢⱼₖₗ, where the indirect communications are measured between nodes i and l, going through the dual mediator nodes j and k, as one possibility.
Block 603: Compare the number of direct communications Tᵢ₀ₖ (ex: 601) to the number of indirect communications (ex: 602) such as Tᵢⱼₖ.

FIG. 7 is a flowchart diagram illustrating a method for determining the ratio of indirect communications to the sum of indirect communications and direct communications, in accordance with one embodiment, including:
Block 701: Determine the ratio Pᵢⱼₖ of the number of indirect communications (602), such as Tᵢⱼₖ , to the sum of indirect communications (602) and direct communications Tᵢ₀ₖ (601), which could, in one embodiment, be expressed mathematically as

$${P}_{ijk} = \frac{{T}_{ijk}}{{T}_{ijk} + {T}_{i 0 k}} .$$

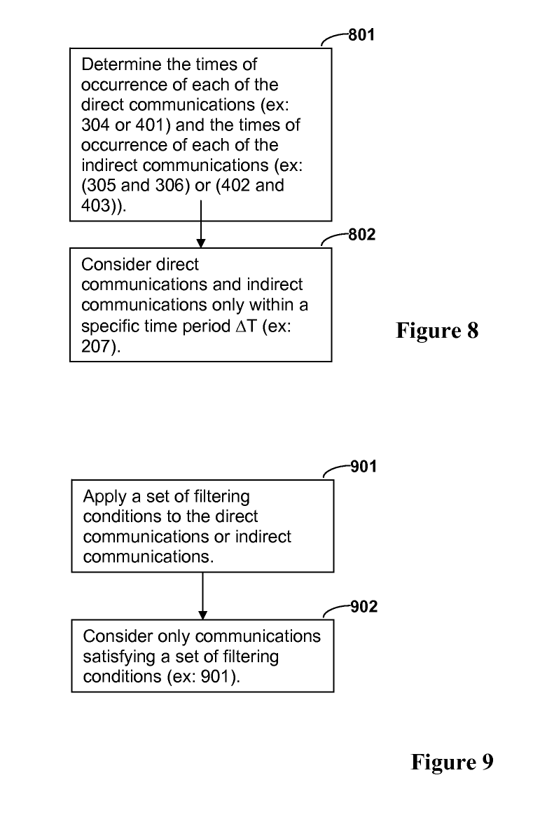

FIG. 8 is a flowchart diagram illustrating a method for filtering communications based on the times of occurrence of each communication, in accordance with one embodiment, including:
Block 801: Determine the times of occurrence of each of the direct communications (ex: 304 or 401) and the times of occurrence of each of the indirect communications (ex: (305 and 306) or (402 and 403)).
Block 802: Consider direct communications and indirect communications only within a specific time period, such as ΔT (ex: 207).

FIG. 9 is a flowchart diagram illustrating a method for filtering communications based on one or more filtering conditions, in accordance with one embodiment, including:
Block 901: Apply a set of filtering conditions to the direct communications or indirect communications.
Block 902: Consider only communications satisfying a set of filtering conditions (ex: 901).

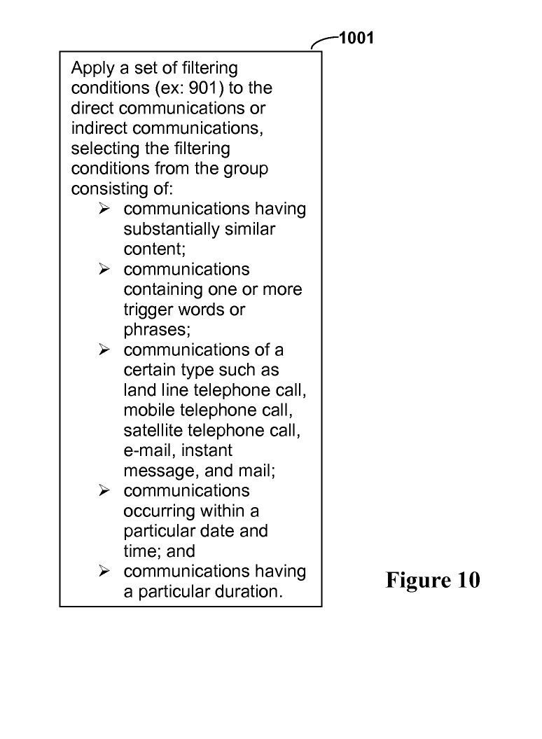

FIG. 10 is a flowchart diagram illustrating a method for filtering communications based on one or more filtering conditions from a list of specific example conditions, in accordance with one embodiment, including:
Block 1001: Apply a set of filtering conditions (901) to the direct communications or indirect communications, selecting the filtering conditions from the group consisting of:
   communications having substantially similar content;
   communications containing one or more trigger words or phrases;
   communications of a certain type such as land line telephone call, mobile telephone call, satellite telephone call, e-mail, instant message, and mail;
   communications occurring within a particular date and time; and
   communications having a particular duration.

The filtering conditions listed above are examples for illustrative purposes only. Additional possible filtering conditions would be evident to persons of ordinary skill in the art. It is anticipated that the selection of filtering conditions to be used would depend on the nature of the network analyzed and the goals of the analysis.

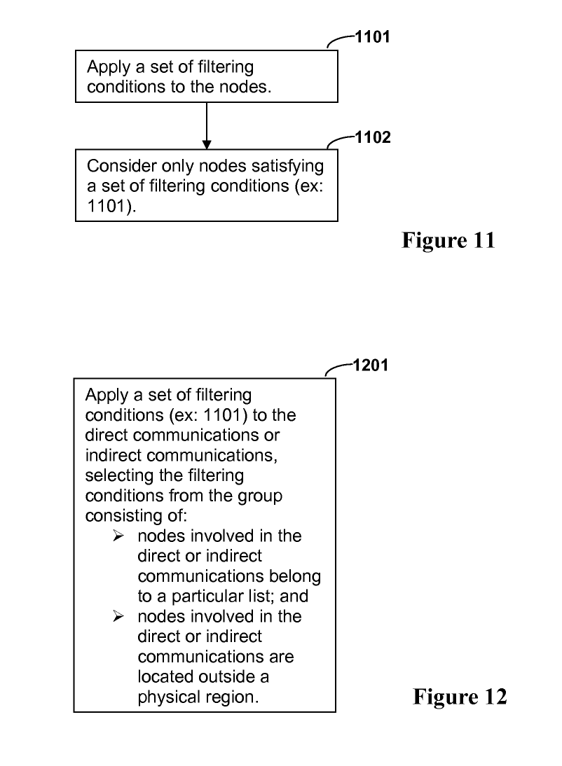

FIG. 11 is a flowchart diagram illustrating a method for filtering network nodes based on one or more filtering conditions, in accordance with one embodiment, including:
Block 1101: Apply a set of filtering conditions to the nodes.
Block 1102: Consider only nodes satisfying a set of filtering conditions (ex: 1101).

FIG. 12 is a flowchart diagram illustrating a method for filtering network nodes based on one or more filtering conditions from a list of specific example conditions, in accordance with one embodiment, including:
Block 1201: Apply a set of filtering conditions (1101) to the direct communications or indirect communications, selecting the filtering conditions from the group consisting of:
   nodes involved in the direct or indirect communications belong to a particular list (such as terrorist watch list or a list of wanted criminals); and
   nodes involved in the direct or indirect communications are located outside a physical region (for example, the United States).

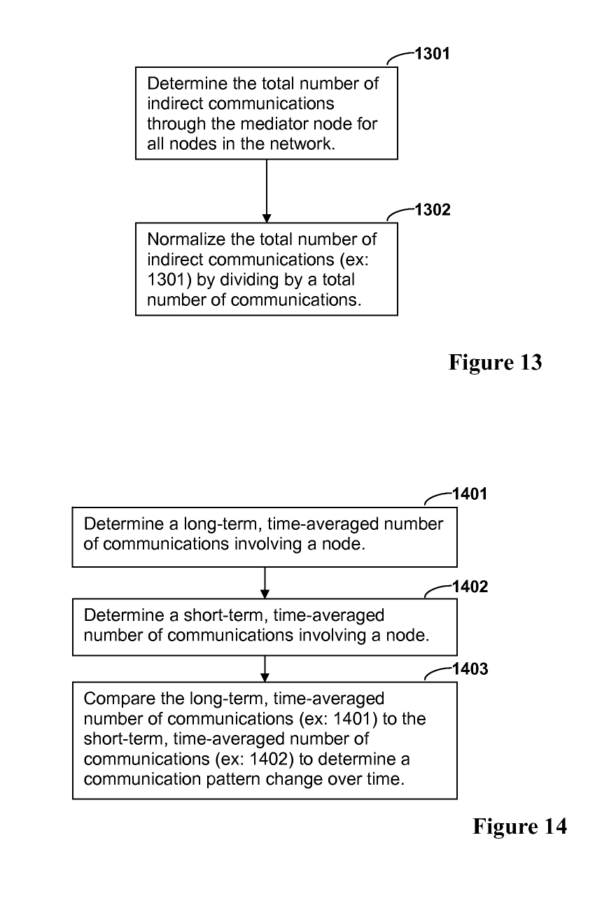

FIG. 13 is a flowchart diagram illustrating a method for determining a normalized number of indirect communications through a mediator node, in accordance with one embodiment, including:
Block 1301: Determine the total number of indirect communications Rⱼ (602), such as Tᵢⱼₖ, through the mediator node j (ex: 302) for all nodes in the network.

If desired, in determining Rⱼ , one could impose a threshold value Rₘᵢₙ below which Rⱼ would be set to 0. This approach could be used to filter out spurious non-zero values of Rⱼ due to random communications that most likely do not represent actual mediated communications.
Block 1302: Normalize the total number of indirect communications Rⱼ (ex:

1301) by dividing by a total number of communications.

In one embodiment, Rⱼ may be expressed as:

$${R}_{j} = \frac{{\sum }_{i , k , i \neq j \neq k} {T}_{ijk}}{{\sum }_{i , k , i \neq j \neq k} {N}_{ijk}} ,$$

where Nᵢⱼₖ is the number of events involving nodes i, j, or k in the time period being analyzed.

FIG. 14 is a flowchart diagram illustrating a method for comparing a long-term, time-averaged number of communications to a short-term, time-averaged number of communications to determine a communication pattern change over time, in accordance with one embodiment, including:
Block 1401: Determine a long-term, time-averaged number Q̅_{j,ΔT} of communications involving a node j (ex: 501). In one embodiment this may be expressed mathematically as:

$${\overline{Q}}_{j , Δ T} = \frac{{Q}_{Δ {T}_{j}} }{Δ T} .$$

Block 1402: Determine a short-term, time-averaged number Q̅_{j,ΔT} of communications involving a node j (ex: 501). In one embodiment this may be expressed mathematically as:

$${\overline{Q}}_{j , Δ t} = \frac{{Q}_{Δ {t}_{j}} }{Δ t} .$$

Block 1403: Compare the long-term, time-averaged number of communications Q̅_{j,ΔT} (ex: 1401) to the short-term, time-averaged number of communications Q̅_{j,ΔT} (ex: 1402) to determine a communication pattern change over time.

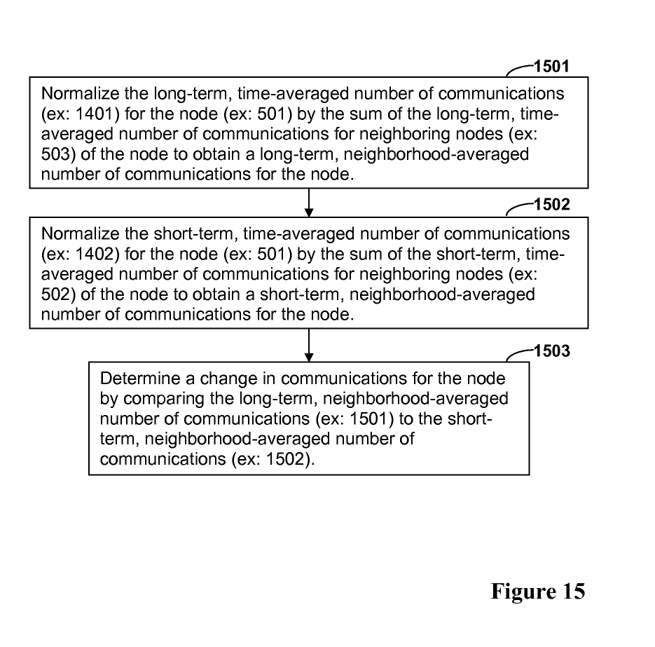

FIG. 15 is a flowchart diagram illustrating a method for comparing a long-term, neighborhood-averaged number of communications to a short-term, neighborhood-averaged number of communications to determine a communication pattern change over time, in accordance with one embodiment, including:
Block 1501: Normalize the long-term, time-averaged number of communications Q̅_{j,ΔT} (ex: 1401) for the node j (ex: 501) by the sum of the long-term, time-averaged number of communications for neighboring nodes

$${\sum }_{k = 1 , {n}_{{tot}_{j}}} {\overline{Q}}_{Δ {T}_{k}}$$

of the node j (where the sum index k ranges over the nodes in the long-term neighborhood (ex: 503) of node j) to obtain a long-term, neighborhood-averaged number of communications \tilde{Q}_{j,ΔT} for the node j. In one embodiment this may be expressed mathematically as:

$${\tilde{Q}}_{j , Δ T} = \frac{{n}_{Δ {T}_{j}} {\overline{Q}}_{Δ {T}_{j}}}{{\sum }_{k = 1 , {n}_{{tot}_{j}}} {\overline{Q}}_{Δ {T}_{k}}} .$$

Block 1502: Normalize the short-term, time-averaged number of communications Q̅_{j,ΔT} (ex: 1402) for the node j (ex: 501) by the sum of the short-term, time-averaged number of communications for neighboring nodes

$${\sum }_{k = 1 , {n}_{{tot}_{j}}} {\overline{Q}}_{Δ {t}_{k}}$$

of the node j (where the sum index k ranges over the nodes in the short-term neighborhood (ex: 502) of node j) to obtain a short-term, neighborhood-averaged number of communications Q̅_{j,ΔT} for the node j. In one embodiment this may be expressed mathematically as:

$${\tilde{Q}}_{j , Δ t} = \frac{{n}_{Δ {t}_{j}} {\overline{Q}}_{Δ {t}_{j}}}{{\sum }_{k = 1 , {n}_{{tot}_{j}}} {\overline{Q}}_{Δ {t}_{k}}} .$$

Block 1503: Determine a change in communications for the node by comparing the long-term, neighborhood-averaged number of communications \tilde{Q}_{j,ΔT} (ex: 1501) to the short-term, neighborhood-averaged number of communications \tilde{Q}_{j,ΔT} (ex: 1502).

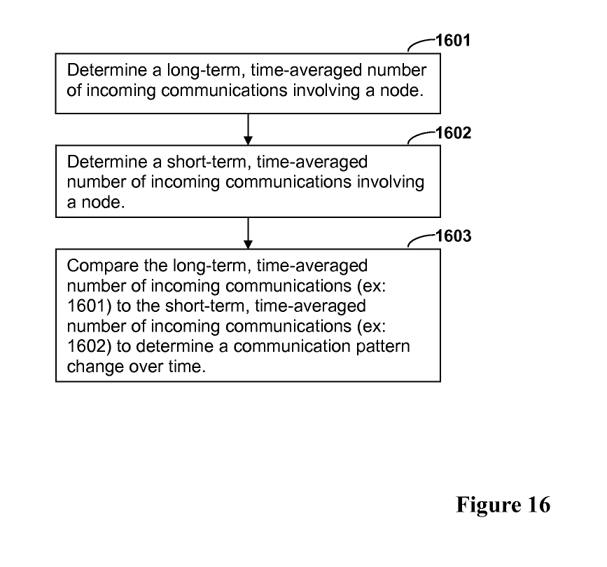

FIG. 16 is a flowchart diagram illustrating a method for comparing a long-term, time-averaged number of incoming communications to a short-term, time-averaged number of incoming communications to determine a communication pattern change over time, in accordance with one embodiment, including:
Block 1601: Determine a long-term, time-averaged number Q̅_{j,ΔT,in} of incoming communications involving a node j (ex: 501).
Block 1602: Determine a short-term, time-averaged number Q̅_{j,ΔT,in} of incoming communications involving a node j (ex: 501).
Block 1603: Compare the long-term, time-averaged number of incoming communications Q̅_{j,ΔT,in} (ex: 1601) to the short-term, time-averaged number of incoming communications Q̅_{j,ΔT,in} (ex: 1602) to determine a communication pattern change over time.

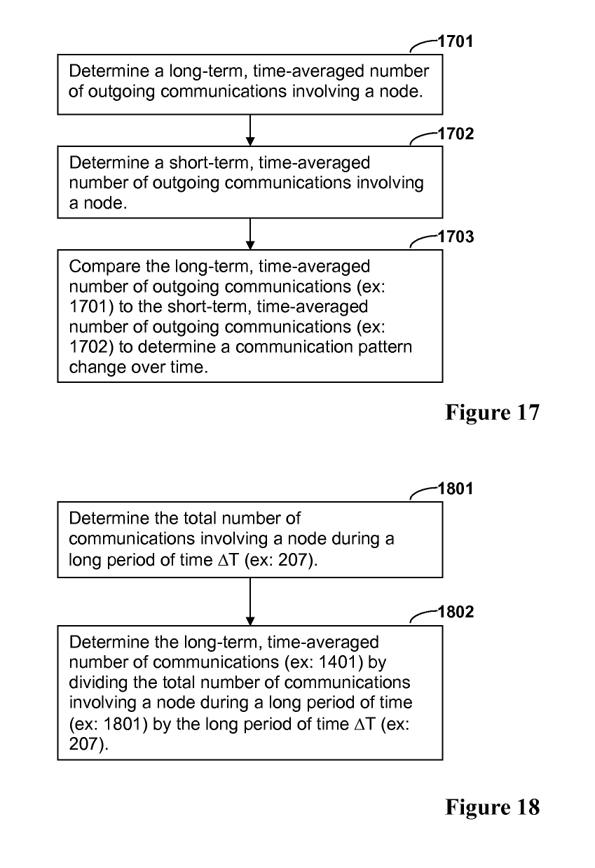

FIG. 17 is a flowchart diagram illustrating a method for comparing a long-term, time-averaged number of outgoing communications to a short-term, time-averaged number of outgoing communications to determine a communication pattern change over time, in accordance with one embodiment, including:
Block 1701: Determine a long-term, time-averaged number Q̅_{j,ΔT,out} of incoming communications involving a node j (ex: 501).
Block 1702: Determine a short-term, time-averaged number Q̅_{j,ΔT,out} of incoming communications involving a node j (ex: 501).
Block 1703: Compare the long-term, time-averaged number of incoming communications Q̅_{j,ΔT,out} (ex: 1701) to the short-term, time-averaged number of incoming communications Q̅_{j,ΔT,out} (ex: 1702) to determine a communication pattern change over time.

FIG. 18 is a flowchart diagram illustrating a method for determining a long-term, time-averaged number of communications involving a node by linear time averaging, in accordance with one embodiment, including:
Block 1801: Determine the total number of communications involving a node j (ex: 501) during a long period of time ΔT (ex: 207).
Block 1802: Determine the long-term, time-averaged number of communications Q̅_{j,ΔT} (ex: 1401) by dividing the total number of communications involving a node j (ex: 501) during a long period of time (ex: 1801) by the long period of time ΔT (ex: 207).

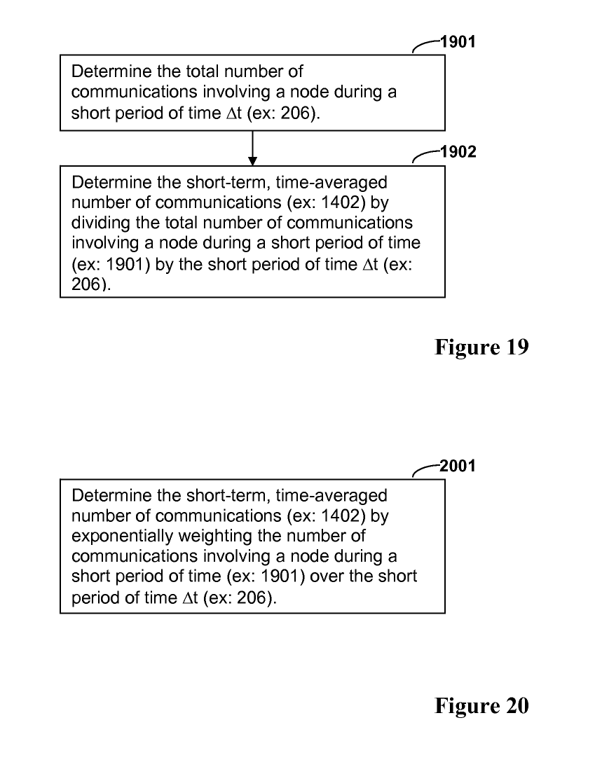

FIG. 19 is a flowchart diagram illustrating a method for determining a short-term, time-averaged number of communications involving a node by linear time averaging, in accordance with one embodiment, including:
Block 1901: Determine the total number of communications involving a node j (ex: 501) during a short period of time ΔT (ex: 206).
Block 1902: Determine the short-term, time-averaged number of communications Q̅_{j,ΔT} (ex: 1402) by dividing the total number of communications involving a node j (ex: 501) during a short period of time (ex: 1801) by the short period of time ΔT (ex: 206).

FIG. 20 is a flowchart diagram illustrating a method for determining a short-term, time-averaged number of communications involving a node by exponential time averaging, in accordance with one embodiment, including:
Block 2001: Determine the short-term, time-averaged number of communications Q̅_{j,ΔT} (ex: 1402) by exponentially weighting the number of communications involving a node during a short period of time (ex: 1901) over the short period of time ΔT (ex: 206).

It should be noted that linear and exponential time averaging are merely two example time averaging methods. Additional possible time averaging methods would be evident to persons of ordinary skill in the art. It is anticipated that the selection of time averaging methods to be used would depend on the nature of the network analyzed and the goals of the analysis.

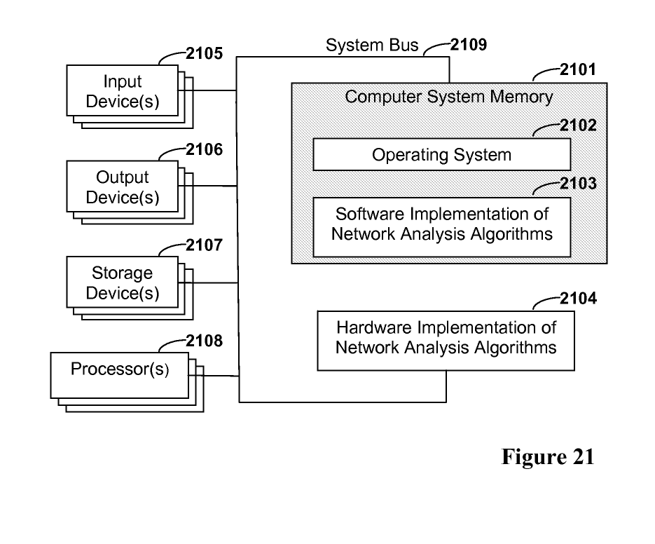

FIG. 21 is a block diagram illustrating one possible embodiment of an information handling system using either or both of a software implementation and a hardware implementation of the network analysis. The example system displayed includes a computer system memory (2101); an operating system (2102); a software implementation of the network analysis (2103); a hardware implementation, such as custom silicon chips, field programmable gate arrays, etc., of the network analysis (2104); one or more general input devices (2105); one or more general output devices (2106), one or more storages devices (2107); one or more processors (2108), and a system bus (2104) connecting the components.

It should be noted that Pᵢⱼₖ and Rⱼ are merely two example mathematical quantities that can be derived from Tᵢⱼₖ and Tᵢ₀ₖ. It will be apparent to those skilled in the art that many alternative quantities could also be calculated based on Tᵢⱼₖ and Tᵢ₀ₖ using standard mathematical techniques, depending upon the goals of the analysis. Such quantities could include, among many other possible ones, means, medians, modes, standard deviations, variances, probability distribution functions, moments, eigenvectors, eigenvalues, spectral decompositions (such as Fourier components), and so on.

One anticipated use of the methods and systems described here is that of an automated detection system to detect and analyze unusual or suspicious patterns of mediated communications in a network. Such a system would be of benefit in anti-terrorism programs and other homeland defense or law enforcement efforts.

One possible means of employing the methods and systems described here to create such a system would consist of the following high-level steps:
Selecting an industry-standard pattern classifier (such as a binary decision tree, a neural network, an associative memory, a support vector machine, etc.) to use for the automated classification process.
Training or initializing the selected pattern classifier to distinguish between normal network communication patterns and mediated network communication patterns by supplying training data sets or parameter values for (a) normal network communication patterns and (b) mediated network communication patterns, using one or more of the network characteristics.
Submitting one or more unknown communication patterns to the trained or initialized pattern classifier to be classified.
If the pattern classifier returns results corresponding to mediated network communication patterns, the automated detection system could warn users appropriately and then present detailed information to enable further analysis.

The proposed automated detection system noted above is one example and for illustrative purposes only. Upon reading this disclosure, many alternative embodiments and uses of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for identifying mediated communications in a network of nodes, the method comprising:
determining the number of direct communications between a first node and a second node;
determining the number of indirect communications between the first node and the second node through one or more mediator nodes; and
comparing the number of direct communications to the number of indirect communications.

2. The method of claim 1, wherein the comparing comprises determining the ratio of indirect communications to the sum of indirect communications and direct communications.

3. The method of claim 1, further comprising:
determining times of occurrence of each of the direct communications and times of occurrence of each of the indirect communications; and
considering direct communications and indirect communications only within a specific time period.

4. The method of claim 1, further comprising:
applying a set of filtering conditions to the direct or indirect communications; and
considering only communications satisfying the set of filtering conditions.

5. The method of claim 1, further comprising:
applying a set of filtering conditions to the nodes; and
considering only nodes satisfying the set of filtering conditions.

6. The method of claim 1, further comprising:
determining a total number of indirect communications through the one or more mediator nodes for all nodes in the network; and
normalizing the total number of indirect communication by dividing by a total number of communications.

7. The method of claim 1, further comprising:
determining a long-term, time-averaged number of communications involving a node;
determining a short-term, time-averaged number of communications involving the node; and
comparing the long-term, time-averaged number of communications to the short-term, time-averaged number of communications to determine a communication pattern change over time.

8. The method of claim 7, further comprising:
normalizing the long-term, time-averaged number of communications for the node by the sum of the long-term, time-averaged number of communications for neighboring nodes of the node to obtain a long-term, neighborhood-averaged number of communications for the node;
normalizing the short-term, time-averaged number of communications for the node by the sum of the short-term, time-averaged number of communications for neighboring nodes of the node to obtain a short-term, neighborhood-averaged number of communications for the node; and
determining a change in communications for the node by comparing the long-term, neighborhood-averaged number of communications to the short-term, neighborhood-averaged number of communications.

9. An information handling system for identifying mediated communications in a network of nodes, the system comprising:
one or more memory units;
one or more processor units; and
one or more input/output devices,
wherein the system is operable to:
determine the number of direct communications between a first node and a second node;
determine the number of indirect communications between the first node and the second node through one or more mediator nodes; and
compare the number of direct communications to the number of indirect communications.

10. The system of claim 9, wherein the system being operable to compare comprises the system being operable to determine the ratio of indirect communications to the sum of indirect communications and direct communications.

11. The system of claim 9, wherein the system is further operable to:
determine times of occurrence of each of the direct communications and times of occurrence of each of the indirect communications; and
consider direct communications and indirect communications only within a specific time period.

12. The system of claim 9, wherein the system is further operable to:
apply a set of filtering conditions to the direct or indirect communications; and
consider only communications satisfying the set of filtering conditions.

13. The system of claim 9, wherein the system is further operable to:
apply a set of filtering conditions to the nodes; and
consider only nodes satisfying the set of filtering conditions.

14. The system of claim 9, wherein the system is further operable to:
determine a total number of indirect communications through the one or more mediator nodes for all nodes in the network; and
normalize the total number of indirect communication by dividing by a total number of communications.

15. The system of claim 9, wherein the system is further operable to:
determine a long-term, time-averaged number of communications involving a node;
determine a short-term, time-averaged number of communications involving the node; and
compare the long-term, time-averaged number of communications to the short-term, time-averaged number of communications to determine a communication pattern change over time.

16. The system of claim 15, wherein the system is further operable to:
normalize the long-term, time-averaged number of communications for the node by the sum of the long-term, time-averaged number of communications for neighboring nodes of the node to obtain a long-term, neighborhood-averaged number of communications for the node;
normalize the short-term, time-averaged number of communications for the node by the sum of the short-term, time-averaged number of communications for neighboring nodes of the node to obtain a short-term, neighborhood-averaged number of communications for the node; and
determine a change in communications for the node by comparing the long-term, neighborhood-averaged number of communications to the short-term, neighborhood-averaged number of communications.

17. A computer program product stored on a computer operable medium, the computer program product comprising software code being effective to:
determine the number of direct communications between a first node and a second node;
determine the number of indirect communications between the first node and the second node through one or more mediator nodes; and
compare the number of direct communications to the number of indirect communications.

18. The product of claim 17, wherein the code being effective to compare comprises the code being effective to determine the ratio of indirect communications to the sum of indirect communications and direct communications.

19. The product of claim 17, wherein the code is further effective to:
determine times of occurrence of each of the direct communications and times of occurrence of each of the indirect communications; and
consider direct communications and indirect communications only within a specific time period.

20. The product of claim 17, wherein the code is further effective to:
apply a set of filtering conditions to the direct or indirect communications; and
consider only communications satisfying the set of filtering conditions.

21. The product of claim 17, wherein the code is further effective to:
apply a set of filtering conditions to the nodes; and
consider only nodes satisfying the set of filtering conditions.

22. The product of claim 17, wherein the code is further effective to:
determine a total number of indirect communications through the one or more mediator nodes for all nodes in the network; and
normalize the total number of indirect communication by dividing by a total number of communications.

23. The product of claim 17, wherein the code is further effective to:
determine a long-term, time-averaged number of communications involving a node;
determine a short-term, time-averaged number of communications involving the node; and
compare the long-term, time-averaged number of communications to the short-term, time-averaged number of communications to determine a communication pattern change over time.

24. The product of claim 23, wherein the code is further effective to:
normalize the long-term, time-averaged number of communications for the node by the sum of the long-term, time-averaged number of communications for neighboring nodes of the node to obtain a long-term, neighborhood-averaged number of communications for the node;
normalize the short-term, time-averaged number of communications for the node by the sum of the short-term, time-averaged number of communications for neighboring nodes of the node to obtain a short-term, neighborhood-averaged number of communications for the node; and
determine a change in communications for the node by comparing the long-term, neighborhood-averaged number of communications to the short-term, neighborhood-averaged number of communications.
